(19) United States
(12) Patent Application Publication
(10) Pub. No.: US 2004/0032425 A1
(43) Pub. Date: Feb. 19, 2004

(54) Method and apparatus for a four dimensional computer operating system environment and display of such environment

(76) Inventor: Ryan Wayne Ross, Chester Springs, PA (US)

Correspondence Address: Ryan Wayne Ross, 1611 Kimberton, Phoenixville, PA, 19460, US

(21) Appl. No.: 10/217,980

(22) Filed: Aug. 13, 2002

(51) Int. Cl. G09G 5/00

(52) U.S. Cl. 345/764

(57) ABSTRACT

Provided is a method for the control and display of a four-dimensional computer operating system. A virtual four-dimensional space continuum is created, in which all interactions of the programs and the user take place. The user interacts with the computer system on a four-dimensional level through the user interface, allowing the system to respond and interact with the user. This invention allows computer systems to interact on a higher level, allowing more information to pass between the user and computer system.

### CROSS-REFERENCE TO RELATED APPLICATIONS

References included in application data sheet 37 CFR § 1.76.

### STATEMENT REGARDING FEDERALLY SPONSORED RESEARCH OR DEVELOPMENT NOT APPLICABLE

### REFERENCE TO SEQUENCE LISTING, A TABLE, OR A COMPUTER PROGRAM LISTING COMPACT DISK APPENDIX NOT APPLICABLE

### BACKGROUND OF THE INVENTION

1. Field of the Invention

The present invention relates to the display of an operating system, and presentation of said operating system to a user through the use of four dimensions.

2. Description of Related Art

Many operating system interfaces make the claim of three-dimensional icons or three-dimensional programs. Since these objects are contained within a two-dimensional operating system interface, they cannot be truly three-dimensional. A true three-dimensional object changes as the viewpoint (point from where a user views the object and surrounding space) changes. A four-dimensional object allows for the object to change not only as the viewpoint changes, but as time changes as well.

The support of a four-dimensional object requires a four-dimensional space continuum, and as three-dimensional objects differentiate from four-dimensional objects so does three-dimensional space differentiate from four-dimensional space continuum. A three-dimensional space allows for three axes: length, height, and width. A four dimensional space continuum allows for four axes: length, height, width, and another axis, referred to as time. Change the viewpoint in three-dimensional space, and the change is apparent in the placement of the objects. Change the viewpoint in four-dimensional space continuum, and the objects may maintain their position but their appearance may change.

Additionally, the four-dimensional space continuum is infinite. While the view of the four-dimensional space continuum may be defined by the user, the four-dimensional space continuum allows for an object to be placed anywhere in space and/or time.

### BRIEF SUMMARY OF THE INVENTION

The object of this invention is to provide a better interface between the user and the computer system.

Operating systems interfaces have evolved over time from a simple command line to the graphical user interface of the computer systems of today. More than ever, the people of this and future generations are opening their eyes to the possibility of another evolution: the three-dimensional operating system interface. Unfortunately, this operating system interface is as limited as those of the old. The objects contained within a three-dimensional operating system interface are static, and often require user intervention to allow for change. In general, one wishes to provide the best possible interface between the user and the computer system. We, as humans, exist in a four-dimensional reality composed of length, height, width, and time. Therefore, the best possible interface for us is one which operates on the same level as ourselves. This invention allows for the creation and interaction of a four-dimensional virtual reality.

The invention's use, aspects, and descriptions will be more thoroughly discussed below.

### BRIEF DESCRIPTION OF THE SEVERAL VIEWS OF THE DRAWING

NOT APPLICABLE

### DETAILED DESCRIPTION OF THE INVENTION

A four-dimensional space continuum is created within the system's memory. Calculations relating to the creation and interaction of the four-dimensional space continuum and the objects contained within may be carried out by the central processor unit (CPU) or another processor specific to the task. Created within this space continuum by the user or the operating system are four-dimensional objects which may be representative of files, processes, programs, or aspects of the operating system. Two-dimensional objects may be created within this continuum by adding information to the program that calls for said object to exist in all time and to exist with a value of zero in another dimension of length, width, or height. Three-dimensional objects may exist by the addition of information to the program that calls for said object to exist in all time. The user may add later modifications to the objects that allow for it to become a four-dimensional object, possibly through defining a definite time for the object to exist, and in the case of a two-dimensional object, the changing of the space axis value of zero to another value.

The user navigates through the continuum by the inputting of values corresponding to the time and space where the user wishes the viewpoint to exist. This navigation may be accomplished be either inputting the values manually through the use of a keyboard, assigning certain keys on a keyboard to support navigation in a direction or time, the use of a mouse and a keyboard, or another peripheral capable of inputting for at least eight directions (relating to the up, down, left, right, forwards, backwards, forwards in time, backwards in time).

The presentation of the four-dimensional operating system may be accomplished by an apparatus capable of projecting a four-dimensional space continuum. A three-dimensional projector with the ability to rapidly update the construct projected may suffice. A two-dimensional display, such as a CRT (cathode ray tube) or a LCD (liquid crystal display) may be able to display a selected portion of the four-dimensional space continuum, but then only from one angle at a time.

The interfacing of the four-dimensional objects with the four-dimensional space continuum is unique in itself. Four-dimensional objects may have the ability to move through the time of the continuum by themselves, as defined by the, user or their programming. They may interact with other four-dimensional objects. They may change their appearance according to the time that they occupy. The space continuum itself may be different according to the viewpoint that the user has selected. One possibility for this invention is for objects to move independently of the continuum, and to occupy multiple spots in time that are not consecutive. The objects may change their appearance, not just the data they represent because of this additional axis. A three-dimensional object is very limited in that by definition, it is three-dimensional and static. The additional axis allows for a full range of changes.

Two other possibilities may exist for this invention. One is for backup purposes, that a user may find that he/she has accidentally deleted a file from his/her current viewpoint, and may go back to an earlier time to retrieve it. Another possibility is that the user may define for objects to exist in many spots along the time axis, and by freezing time or setting off certain intervals to loop them; a user may create multiple desktops. By isolating these intervals or setting certain objects to expire beyond these intervals, a user may be able to create many virtual realities.

The applications for another axis, time, in addition to the other three space axis, allows for interaction on a higher level. With this invention a user may finally be able to fully interact with the computer system. With full interaction, the user may make more efficient use of his/her time, as he/she cannot control time in quite the way one might the time in a four-dimensional space continuum.

I claim:

1. An apparatus whereby a computer system composed of an input device, display device, memory, CPU, and source of power may interact on a basic system level with a user by means of visual representation through the use of a four-dimensional space continuum (consisting of four axes) and four-dimensional objects.

2. The method of claim 1 allowing for the use of a four-dimensional space continuum comprising four axes corresponding to length, width, height, and another dimension, referred to as time.

3. The method of claim 1 allowing for the use of four-dimensional objects in a four-dimensional space continuum.

4. The method of claim 1 allowing for the interfacing of the four-dimensional objects with the four-dimensional space continuum.

5. The method for backwards compatibility of the four dimensional space continuum and the objects contained within it with two-dimensional displays.

6. The method for the existence of two- and three-dimensional objects within a four-dimensional space continuum.

7. The method of claim 1 for the navigation of a four-dimensional space continuum through the use of an input device.
